(19) United States
(12) Patent Application Publication
(10) Pub. No.: US 2003/0089182 A1
(43) Pub. Date: May 15, 2003

(54) Flexible structure with integrated sensor/actuator

(76) Inventors: Jacob Thaysen, Copenhagen (DK); Ole Hansen, Horsholm (DK); Aric Menon, Hellerup (DK); Anja Boisen, Valby (DK)

Correspondence Address: BIRCH STEWART KOLASCH & BIRCH, PO BOX 747, FALLS CHURCH, VA, 22040-0747, US

(21) Appl. No.: 10/235,542

(22) Filed: Sep. 6, 2002

Related U.S. Application Data
(63) Continuation-in-part of application No. 10/006,582, filed on Dec. 10, 2001.
(60) Provisional application No. 60/317,488, filed on Sep. 7, 2001.

(51) Int. Cl. G01L 1/04

(52) U.S. Cl. 73/862.621; 219/540

(57) ABSTRACT

A polymer-based flexible structure with integrated sensing/actuator means is presented. Conventionally, silicon has been used as a piezo-resistive material due to its high gauge factor and thereby high sensitivity to strain changes in a sensor. By using the fact that e.g. an SU-8 based polymer is much softer than silicon and that e.g. a gold resistor is easily incorporated in SU-8 based polymer structure it has been demonstrated that a SU-8 based cantilever sensor is almost as sensitive to stress changes as the silicon piezo-resistive cantilever.

### FIELD OF THE INVENTION

The present invention relates to a flexible structure comprising an integrated sensing/actuating element or elements. The integrated sensing/actuating elements are electrically accessible and at least partly encapsulated in a flexible and electrically insulating body so that the flexible structure may be operable in e.g. an electrically conducting environment.

### BACKGROUND OF THE INVENTION

The use of e.g. SU-8 based (glycidyl ether of bisphenol A) polymers within the MEMS field has been exponentially growing during the last couple of years. SU-8 based polymers are know in the art as being an epoxy-based photosensitive polymer which may be used as a negative photoresist. SU-8 based photoresists are sensitive to light exposures in the near UV region—typically in the wavelength range from 365 nm to 436 nm. The fact that SU-8 based polymers are very chemically and thermally resistant makes it possible to use this group of polymers as a component materials. Due to its capability of defining layers with thickness' between 1 μm and 1 mm with high aspect ratios (>20), SU-8 based polymers have been a popular and cheap alternative to silicon for the fabrication of passive components. Such components include micro-channels, micro-molds for electroplating or masters for hot embossing. Passive SU-8 based atomic force microscopy (AFM) cantilevers have also been demonstrated.

WO 00/66266 discloses silicon-based micro-cantilever, micro-bridge or micro-membrane type sensors having piezo-resistive readout so as to form an integrated readout mechanism. Such micro-cantilevers, micro-bridges or micro-membranes sensors are suitable for use in micro-liquid handling systems so as to provide an integrated detection scheme for monitoring physical, chemical and biological properties of liquids handled in such systems. Since silicon exhibits 1) superior mechanical behavior and 2) has a very high piezo-resistive coefficient, silicon has been the obvious material when sensors with integrated readout were to be designed and fabricated.

However, in case silicon-based sensors with integrated readout are to be operated in a conducting liquid environment—such as in micro-liquid handling systems, encapsulation of the electronic circuit constituting the integrated readout is required—otherwise, the electronic circuit will short-circuit causing the integrated readout and thereby the sensor as a whole to fail to operate.

Furthermore, fabrication of silicon-based sensor are rather complicated due to the comprehensive process sequence required in order to fabricate such sensors. A consequence of the comprehensive process sequence is directly reflected in the fabrication costs causing the fabrication of silicon-based sensors to be very expensive.

U.S. Pat. No. 6,087,638 discloses a thermal actuator comprising an inner conductive material encapsulated in a non-conductive expansive material, such as polytetraflouroethylene (PTFE)—see column 2, line 24. Preferably, the conductive material is formed as a corrugated copper heating element (see column 2, lines 23-24) so as to increase the rate of thermal transfer to the non-conductive expansive material encapsulating the copper heating element. The thermal actuator of U.S. Pat. No. 6,087,638 is preferably applied in ink jet printers where ink is ejected through nozzles when the thermal actuator is activated.

It is evident that it is the non-conductive expansive material that causes the actuator of U.S. Pat. No. 6,087,638 to deform/bend. This deformation/bending is induced by exposing the non-conductive material to heat via the thermal actuator which causes the non-conductive material to expand whereby the actuator as a whole is activated.

The fact that heat is what causes the actuator of U.S. Pat. No. 6,087,638 to bend requires that a significant amount of power needs to be provided to the actuator. Even further, in case the actuator of U.S. Pat. No. 6,087,638 is to be applied in micro-liquid handling systems the heating of the actuator may cause the temperature of the surrounding liquid to increase which, in some situations, would be disadvantageous. In a worst case scenario, the increased temperature could initiate a chemical reaction in the liquid.

It is an object of the present invention to provide a solution to the above-mentioned disadvantages of conventional systems. Thus, it is an object of the present invention to provide a sensor/actuator configuration including an encapsulating and electrically insulating body so that the sensor/actuator may be immersed directly into a conducting liquid environment without the use of a separate encapsulation layer so as to avoid short-circuit of electronic components forming the integrated readout/integrated actuator. An advantage of such a sensor/actuator is that it can be operated in conducting liquid environment without the use of the before-mentioned encapsulation layer.

It is a further object of the present invention to provide a sensor/actuator with integrated readout/actuator which is cheaper and easier to fabricate compared to conventional systems.

### SUMMARY OF THE INVENTION

The above-mentioned objects are complied with by providing, in a first aspect, a flexible structure comprising integrated sensing means, said integrated sensing means being at least partly encapsulated in a flexible and electrically insulating body, said integrated sensing means further being adapted to sense deformations of the flexible structure.

The flexible structure may be a micro-cantilever having a rectangular form. Typical dimensions of such micro-cantilever may be: width: 50-150 μm, length: approximately 200 μm, and thickness 1-10 μm. Alternatively, the flexible structure may be a micro-bridge having its ends attached to the walls of e.g. an interaction chamber in an liquid handling system. The dimensions (wide, length and thickness) of a micro-bridge may be similar to the dimensions of the micro-cantilever. Alternatively, the flexible structure may be a membrane-like structure forming part of e.g. the side-walls of an interaction chamber. The flexible structure may also be a stress sensitive membrane—example for use in pressure sensors.

The flexible and electrically insulating body may be a polymer-based body, such as a photosensitive polymer. A first and a second polymer layer may form this flexible polymer-based body where the integrated sensing means is embedded into the first and/or the second polymer layer.

The integrated sensing means (sensing element or elements) may be a resistor formed by a conducting layer—for example a metal layer such as a gold layer. The resistance of the resistor is dependent on deformations of the flexible structure whereby deformations of the flexible structures may be detected. Alternatively, the conducting layer may comprise a semiconductor material, such as silicon. In case of silicon, the resistor will be a so-called piezo-resistor which may be integrated in the polymer-based body using sputtering.

An SU-8 based polymer may form the flexible polymer-based body. Other suitable groups of photosensitive polymers are polyimide and BCB cyclotene polymers. In case the polymer-based body is formed by two layers of polymers these layers may both be SU-8 based, such as XP SU-8, polyimides or BCB cyclotene polymers or any combination thereof.

In the following, the present invention will be described in detail with reference to SU-8 based polymers only. However, this should not be regarded as a limitation with regard to choice of polymer material—polyimide and BCB cyclotene polymers could be used as well.

As already mentioned, SU-8 based polymers are know in the art as being an epoxy-based negative photoresist which are sensitive to light exposures in the near UV region (typically in the range 365-436 nm). SU-8 based polymers are characterized as being chemically and thermally stable which makes them attractive for device proposes.

The flexible structure may further comprise a substantially rigid portion so as to form a chip, the chip further comprising an integrated electrical conductor being at least partly encapsulated in an electrically insulating body, said integrated electrical conductor being connected to the integrated sensing means and being electrically accessible via a contact terminal on an exterior surface part of the substantially rigid body.

The substantially rigid portion may be that part of a micro-cantilever, which is supported by a substrate. As well as the flexible structure, the substantially rigid body may be formed by a first and a second polymer layer. The integrated electrical conductor may be at least partly embedded into the first and/or the second polymer layer. These polymer layers may be SU-8 based polymer layers, such as XP SU-8 polymer layers.

The integrated electrical conductor may be formed by a metal layer—for example a gold layer. Alternatively, the integrated electrical conductor may comprise a semiconductor material—for example sputtered silicon. The chip may further comprise at least three resistors, the at least three resistors forming part of the substantially rigid portion of the chip. The at least three resistors may be embedded into the first and/or the second polymer layer of the substantially rigid portion. In a preferred embodiment the chip comprises three resistors.

In a second aspect, the present invention relates to a chip comprising two or more flexible structures according to the first aspect, said chip further comprising additional resistors on a substantially rigid portion of the chip. In one embodiment, the chip comprises two flexible structures according to the first aspect, the chip further comprising a substantially rigid portion comprising integrated electrical conductors each being at least partly encapsulated in an electrically insulating body, a number of said integrated electrical conductors being connected to the integrated sensing means and being electrically accessible via contact terminals on an exterior surface part of the substantially rigid portion. The chip may further comprise two resistors, the two resistors forming part of the substantially rigid portion of the chip. The substantially rigid portion may comprise a first and a second polymer layer, and wherein the integrated electrical conductors and the two resistors are at least partly embedded into the first and the second polymer layer of the substantially rigid portion of the chip

Preferably, these four resistors are connected so as to form a Wheatstone Bridge in combination.

The substrate may be a polymer substrate, such as a SU-8 based polymer substrate, or, alternative, the substrate may be e.g. a semiconductor material, a metal, glass, or a plastic substrate. A suitable semiconductor material is silicon.

In a third aspect, the present invention relates to a sensor for measuring the presence of a substance in a fluidic, Such sensor may comprise a chip according to the second aspect. Such sensor could be a micro-cantilever, micro-bridge or micro-membrane type sensor having integrated readout. A closed micro-liquid handling system allows laminated flows of different liquids to flow in the channel without mixing, which opens up for new type of experiments and which reduces noise related to the liquid movement. Neighbouring or very closely spaced micro-cantilevers, micro-bridges or micro-membranes can be exposed to different chemical environments at the same time by:

Laminating the fluid flow vertically in the micro-channel into two or more streams, so that micro-cantilevers or micro-membranes on opposing sides of the micro-channel are immersed in different fluids, or so that a micro-cantilever, micro-bridge, or micro-membrane is exposed to two different fluids.

Laminating the fluid flow horizontally in the micro-channel, so that micro-cantilevers or micro-bridges recessed to different levels in the micro-channel or micro-membranes placed at the top and at the bottom of the channel are exposed to different fluids.

In this way, changes in viscous drag, surface stress, temperature, or resonance properties of adjacent or closely spaced micro-cantilevers, micro-bridges or micro-membranes induced by their different fluid environments, can be compared.

Neighbouring or very closely spaced micro-cantilevers, micro-bridges or micro-membranes can be coated with different chemical or biological substances for immersing adjacent or neighbouring micro-cantilevers, micro-bridges or micro-membranes in different fluids.

In micro-cantilever, micro-bridge or micro-membrane based sensors, the liquid volume may be minimised in order to reduce the use of chemicals and in order to obtain a system which is easy to stabilise thermally.

In a fourth aspect, the present invention relates to an actuator comprising a flexible structure, said flexible structure comprising integrated actuator means being electrically accessible and being at least partly encapsulated in a flexible and electrically insulating body, said integrated actuator means being adapted to deform upon accessing the integrated actuator means electrically thereby inducing deformations of the flexible structure in accordance with deformations of the integrated actuator means.

The integrated actuator means (actuator element or elements) may comprise at least one metal layer. The flexible and electrically insulating body may be a polymer-based body formed by for example an SU-8 based polymer. In one embodiment, two different metal layers may be slightly heated whereby actuation may be achieved via the bimorph effect due to different thermal expansions of the two metal layers.

In a fifth aspect, the present invention relates to a chip comprising an actuator according to the fourth aspect, further comprising a polymer-based substrate supporting a substantially rigid portion of the chip. The substrate may be formed in a photosensitive polymer, such as an SU-8 based polymer. Alternatively, the substrate may be a silicon-based substrate supporting the substantially rigid portion of the chip.

In a sixth aspect, the present invention relates to a method of manufacturing a chip, the method comprising the steps of

providing a first electrically insulating layer,

patterning the first electrically insulating layer so as to form a first part of a flexible cantilever,

providing, onto a first area of the layer forming the first part of the flexible cantilever, a first conducting layer, and patterning the first conducting layer so as to form at least one conductor on the first area of the patterned first electrically insulating layer,

providing, onto a second and different area of the layer forming the first part of the flexible cantilever, a second conducting layer, and patterning the second conducting layer so as to form at least one resistor on the second area of the patterned first electrically insulating layer, and

providing, onto the first and second areas of the layer forming the first part of the flexible cantilever, a second electrically insulating layer so as to at least partly encapsulate the at least one conductor and the at least one resistor, and patterning the second electrically insulating layer so as to form a second part of a cantilever.

Preferably, the at least one conductor on the first area is connected to at least one resistor on the second area.

The electrically insulating layers may be polymer layers—for example SU-8 based polymer layers. The conducting layers may be metal layers—for example gold layers.

The method may further comprise the steps of providing a third layer onto the second electrically insulating layer, and patterning the third layer so as to form a substrate that only supports the first area of the second electrically insulating layer. The third layer may be a polymer-based layer, such as an SU-8 based layer. Alternatively, the third layer may be a silicon-based layer. The method may further comprise the steps of

providing a sacrificial layer on a silicon wafer, upon which the first electrically insulating layer is provided, and

removing the silicon wafer after providing and patterning of the third layer.

### BRIEF DESCRIPTION OF THE DRAWINGS

The present invention will now be explained in further details with reference to the accompanying figures, where

FIG. 1 shows a process sequence for the fabrication of a polymer-based cantilever—here a SU-8 based polymer body,

FIG. 2 shows an example of a complete chip design,

FIG. 3 shows optical images of cantilevers with integrated meander-type resistor, and

FIG. 4 shows the relative change in resistance as a function of the cantilever deflection.

### DETAILED DESCRIPTION OF THE INVENTION

As previously mentioned, the flexible structure may be the movable part of a cantilever beam, the movable part of a micro-bridge, or the movable part of a diaphragm. A detailed description of the present invention will now be provided with reference to a polymer-based cantilever-like structure. This exemplification should, however, not be regarded as a limitation of the present invention to polymer-based cantilever-like structures.

In the following, the sensitivity of an SU-8 based cantilever with integrated piezo-resistive readout is compared to the sensitivity of a conventional piezo-resistive silicon cantilever. In this comparison the surface stress sensitivity is compared for the two different sensors.

When molecules bind to a surface of a cantilever, the surface stress σₛ, changes due to molecular interactions. This stress change can then be detected by the integrated piezo-resistor. A simple expression for the sensitivity can be obtained by assuming that the cantilever consists of only one material and an infinitely thin resistor placed on top of the cantilever. The relative change in resistance can then be determined as:

$$\frac{Δ R}{R} / {σ}_{S} = - K \cdot \frac{4}{h \cdot E}$$

where K is the gauge factor, E is Young's modulus and h is the thickness of the cantilever.

Preferably, a thin gold film is used as the piezo-resistor. Gold has a low gauge factor (K_{Au}=2) compared to silicon (K_{Si}=140) and is therefore considered inferior to silicon as a piezo-resistive sensor material.

From the equation it is seen that the K/E actually determines the stress sensitivity of the cantilever for the same thickness. Since SU-8 based polymers have a Young's modulus of 5 GPa and silicon has a Young's modulus of 180 GPa, the ratios becomes (K/E)_{Si}=0.8 GPa⁻¹ and (K/E)_{SU-8/Au}=0.4 GPa⁻¹, which is only a factor of 2 in sensitivity in favor of silicon. The sensitivity of an SU-8 based piezo-resistive cantilever can be further enhanced by integrating a piezo-resistor material with even higher gauge factor. For example, it is possible to integrate a sputtered silicon piezo-resistor with a gauge factor of about 20. In order to use Youngs's modulus for SU-8 in the K/E relation, the stiffness of the piezo-resistor should be neglectable compared to the SU-8 cantilever. This can be achieved by reducing the thickness of the poly-silicon resistor which increases the noise significantly and thereby reducing the signal to noise ratio.

Preferably, an SU-8 based cantilever with integrated piezo-resistive readout is fabricated on a silicon substrate. The substrate is only used in order to be able to handle the chips during processing.

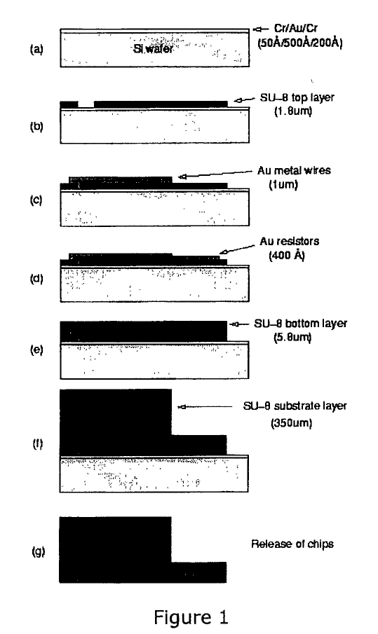

First, a Cr/Au/Cr layer is deposited on the silicon wafer as shown in FIG. 1a. This Cr/Au/Cr layer is used as a very fast etching sacrificial layer. A first layer of SU-8 is then provided, preferably by spinning, on the wafer and patterned as an upper cantilever layer—see FIG. 1b. The thickness of this layer is typically in the range of a few microns—for example in the range 1-5 μm. In FIG. 1b, the thickness of the first layer is 1.8 μm.

A gold layer with a thickness of approximately 1 μm is then deposited on top of the patterned thin SU-8 layer. A conductor is transferred to the SU-8 layer by standard photoresist/photolithography. This conductor is defined by etching—see FIG. 1c.

In FIG. 1d, another gold layer with a thickness of approximately 400 Å is deposited and a resistor is defined following the same procedure as described in connection with FIG. 1c.

The conductor and the resistor are encapsulated in SU-8 by depositing and patterning of a second SU-8 layer. This second polymer layer forms the lower part of the cantilever—see FIG. 1e. Preferably, the thickness of this second layer is within the range 3-10 μm. In FIG. 1e, the thickness of the second layer is 5.8 μm.

Finally, an SU-8 based polymer layer (approximately 350 μm thick) is spun on the second SU-8 layer and patterned as the chip substrate (FIG. 1f). The chip is finally released by etching of the sacrificial layer—see FIG. 1g.

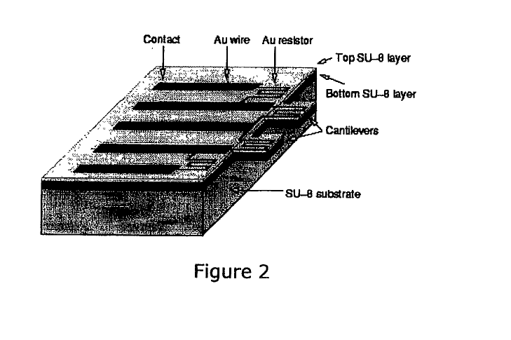

FIG. 2 shows an SU-8 based cantilever chip design comprising two SU-8 cantilevers. As seen, the chip consists of two cantilevers with integrated gold resistors and two gold resistors on the substrate. The four resistors are connected via gold wires in such a way that they in combination form a Wheatstone bridge. The nodes of the Wheatstone bridge are accessible via the shown contact pads.

The advantage of the design shown in FIG. 2 is that one of the cantilevers may be used as a measurement cantilever, while the other cantilever may be used as a common-mode rejection filter. Typical parameters of the cantilevers shown in FIG. 2 are as follows:

TABLE 1
Typical design parameter:

| Parameter | Value | Unit |
|---|---|---|
| Cantilever length | 200 | μm |
| Cantilever width | 100 | μm |
| Cantilever Thickness | 7.3 | μm |
| Spring constant | 7 | N/m |
| Resonant frequency | 49 | kHz |

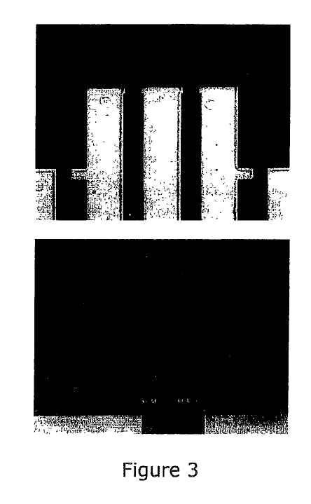

In FIG. 3, optical images of a fabricated chip are shown. In FIG. 3a, both cantilevers are seen. FIG. 3b shows a close-up of one of the cantilevers. The meander-like resistor structure is clearly seen in the image.

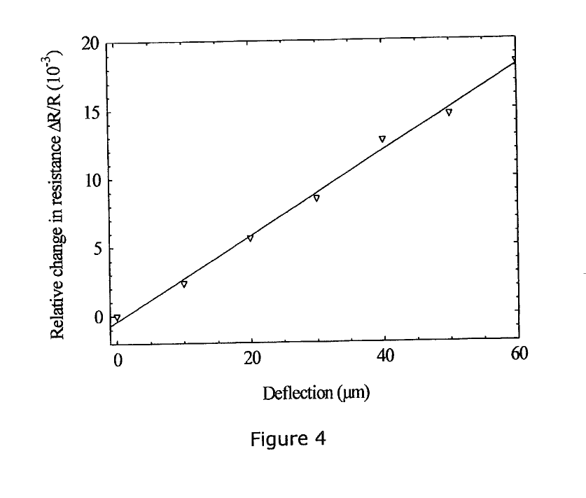

The deflection sensitivity of piezo-resistive SU-8 cantilevers has been measured by observing the relative change in resistance as a function of the cantilever deflection—the result is shown in FIG. 4. It is seen that a straight line can be obtained from the measurement, which indicates that the deformation is purely elastic.

From FIG. 4, the deflection sensitivity can be determined from the slope of the straight line to

$$\frac{Δ R}{R} / z = 0.3 p p m / nm ,$$

which yields a gauge factor of K=4. The minimum detectable deflection or minimum detectable surface stress is given by the noise in the system. Since the vibrational noise is considerably lower than the electrical noise sources in the above-mentioned resistor setup, only the Johnson noise and the 1/f noise may be considered. The noise has been measured as a function of frequency for different input voltages. It was observed that the 1/f noise was very low with a knee frequency of about 10 Hz for a Wheatstone bridge supply voltage of 4.5 V.

TABLE 2
Performance of the SU-8 based piezo-resistive cantilever compared to
a piezo-resistive silicon cantilever.

| | SU-8 | Si cantilever |
|---|---|---|
| Parameter | cantilever | (optimized) |
| Deflection sensitivity [nm]⁻¹ | 0.3 × 10⁻⁶ | 4.8 × 10⁻⁶ |
| Minimum detectable deflection [Å] | 4 | 0.4 |
| Surface stress sensitivity [N/m]⁻¹ | 3x · 10⁻⁴ | 1x · 10⁻³ |
| Minimum detectable surface stress | 1x · 10⁻⁴ | 2x · 10⁻⁵ |
| [N/m] | | |

From the above measurements it is possible to summarize the performance of the SU-8 based piezo-resistive cantilever—table 2.

With respect to deflection sensitivity, minimum detectable deflection, surface stress sensitivity and minimum detectable surface stress, the performance is compared to an optimized silicon piezo-resistive cantilever.

It is seen from table 2, that the minimum detectable deflection is 10 times better for the silicon cantilever, but only 5 times better regarding the minimum detectable surface stress. Thus, the SU-8 based piezo-resistive cantilever may e.g. be used as a surface stress bio-chemical sensor, since the change in surface stress due to molecular interactions on a cantilever surface is normally in the order of 10⁻³-1 N/m.

Reducing the thickness of the cantilever can increase the surface stress performance even further. As seen from the previously show equation, the sensitivity is inversely proportional with the thickness. With the given technology it is possible to decrease the cantilever thickness a factor of 2 and thereby decrease the minimum detectable surface stress with a factor of 2.

While the present invention has been described with reference to a particular embodiment—micro-cantilevers, those skilled in the art will recognise that many changes may be made thereto without departing from the spirit and scope of the present invention. Such changes could be the appliance of the concept of the present invention to micro-bridges, micro-membrane or diaphragms or similar micro-mechanical structures.

For example, the principle of encapsulating a thin gold resistor into a compliant SU-8 structure can also be used for different kinds of sensors, such as stress sensitive micro-bridges or stress sensitive membranes for example used as pressure sensors or bio-sensors, such as micro-liquid handling systems.

In bio-sensors, measurements of the properties of fluids—especially liquids—flowing in microscopic channels is of importance. In such sensors, the following properties would be determinable using the present invention:

1) physical properties such as flow rates viscosity and local temperature

2) chemical properties such as pH and chemical composition

3) biological properties such as identification of organic constituents in fluids, including DNA fragments, proteins, and complete biological cells

Micro-liquid handling systems typically consist of narrow channels of order 100 microns wide and 100 microns deep engraved or embossed into the surface of a thin wafer of a material such as silicon, glass, plastic or polymers using reproduction techniques based on micromachining. The surface containing the channels is usually bonded to another surface, in order to seal the channels. Fluids pumped through the resulting channels typically flow in a completely laminar fashion. As a result, several different fluids can be flowed in laminated streams through such Microsystems, without any significant mixing of the fluids.

An important advantage of a micro-liquid handling system is that very small quantities of fluid can be directed in a controlled fashion to various parts of the system, where various analytical techniques can be used to determine the properties of the liquid. This can be done using external analytical techniques such as optical detection. The controlled flow of the fluid is achieved via pumps and valve systems that can be either external or integrated with the micro-channels.

A change in the mechanical properties of a micro-cantilever can for example be a stress formation in the micro-cantilever due to changes in surface stress of the micro-cantilever. Stress formation can also occur due to changes in temperature of the micro-cantilever due to a bimorph effect, if the micro-cantilever is made of two materials with different thermal expansion coefficients. Such stress formations in the micro-cantilever can detected as a change in the resistivity of a piezo-resistor embedded into the micro-cantilever body.

Change in resonance frequency is another example of a change in a mechanical property. A change in mass of the micro-cantilever can occur if material binds to the micro-cantilever, and such a change will produce a change in the resonance frequency of the micro-cantilever. Such changes can be monitored by actuating the micro-cantilever at a frequency near its resonance frequency, and monitoring changes in the amplitude of the resulting dynamic bending of the micro-cantilever, using the integrated sensing means as described above for the detection of stress formation.

In the following, examples of different applications of the present invention are listed and commented. However, the application of the present invention should naturally not be limited to the listed examples.

In sensors supporting laminated flows, adjacent or very closely spaced micro-cantilevers can be exposed to different chemical environments at the same time by

1) Laminating the fluid flow vertically in the micro-channel into two or more streams, so that micro-cantilevers on opposing sides of the micro-channel are immersed in different fluids.

2) Laminating the fluid flow horizontally in the micro-channel, so that micro-cantilevers recessed to different levels in the micro-channel are immersed in different fluids.

3) Laminating the fluid flow either horizontally or vertically and moving the micro-cantilevers through the different fluids by actuating the micro-cantilevers.

In case of laminated fluids, micro-cantilever signals from different fluidic environments can be compared. Moreover, the technology can be used for coating narrowly spaced micro-cantilevers with different chemical substances. Examples on both aspects will be described below.

Functionalisation of micro-cantilevers can be performed using conventional immobilisation chemistry, which easily applies to the micro-cantilever materials. However, for the closely spaced micro-cantilevers in micro-channels new technologies for applying the different coatings are needed. The functionalisation of narrowly spaced micro-cantilevers can be performed by one or more of the technologies described below:

1) In the micro-fabrication of the device, the micro-cantilevers can be coated with different thin film layers which are compatible with the fabrication process. The thin films can be metal, silicon and dielectric layers. The different thin films can then be used to bind molecules which have a specific binding to a specific thin film.

2) The molecules to be attached on the micro-cantilever surface can be synthesised with a photo activated binding site. Molecules are then attached to the micro-cantilever surface by placing the micro-cantilever in a liquid solution with the coating molecules and exposing the micro-cantilever to UV light. The UV light induces the creation of a bond between the micro-cantilever surface and molecules. This coating can be performed in the channel after it has been closed, by injecting different coating molecules in the channel and illuminating the micro-cantilevers individually through the cover plate. By scanning a laser across the device small well-defined areas can be coated with specific coatings. Between each coating the system must be rinsed and a new coating solution injected in the channels.

3) Using an inkjet printer principle small droplets of liquid can be delivered. These systems are commercially available for DNA chip fabrication. Such a liquid delivery system can be used to spray droplets of different liquids on closely spaced micro-cantilevers. The delivered droplets typically have a diameter of 100 μm. This coating technique must be performed before the channel is sealed.

4) When the channels are sealed, laminated flow can be used to coat narrowly spaced micro-cantilevers by having two or more laminated flows in the system. Micro-cantilevers placed in different heights and/or on different sides of the channel will thus be immersed in different liquids. After coating, the micro-channels can be flushed with other fluids to remove the residual coating material. By repeating the technique, several layers of coating can be added to the micro-cantilever. In order to bind molecules to only one side of the micro-cantilever photoimmobilisation or pre-deposited thin films can be used.

5) Selective coating can be performed by laminating two or more streams in the micro-channel and placing the micro-cantilever in one of the streams by a static bending. Moreover, a controlled movement of the micro-cantilever through separated laminated streams can be used to coat the micro-cantilever with multiple layers such as glutaraldehyde-avidin-biotin.

6) Selective and reversible coating of the micro-cantilever, with for example metalloproteins, can be acheived electrochemically. A conducting layer on the micro-cantilever can be used as the working electrode. The counter electrode might be an integrated part of the system. Also it is often desirable to include a reference electrode for control of the applied potential.

To minimise the effect of turbulence and thermal drift in a sensor system, a reference micro-cantilever can be introduced. The reference micro-cantilever is placed close to the measurement micro-cantilever and in the same measurement environment. However, the reference micro-cantilever is not coated with a detector film. The reference micro-cantilever might be coated with another film which does not act as a detector or which detects a second substance. By subtracting the reference signal from the measurement signal most background noise can be eliminated.

For most biochemical applications it is important to perform a reference measurement in a reference liquid. Often it is the increase/decrease in the concentration of a specific molecule which is of interest. For such relative measurements, a reference liquid is required. The micro-cantilever placed in the reference solution should be identical to the measurement micro-cantilever in the measurement solution. The measurement solution and the reference solution can be investigated in the same channel at the same time by laminating the flow and let the two streams run in parallel. Micro-cantilevers placed on either side of the channel will measure the reaction in two different fluids. Quasi-simultaneous measurements in analytes and in reference solutions can be performed by moving the micro-cantilever through the two liquids.

Molecules which bind to the detector films on the micro-cantilever change the stress of the film, which results in a micro-cantilever bending. For example, diffusion in cell micro-membranes can be investigated and the activity of specific micro-membrane channels which are regulated by voltage or by the binding of another molecule can be investigated. Time dependent response from micro-cantilevers can be used to investigate the dynamics of layer formation on the micro-cantilever surface. For example the formation of self-assembled monolayers can be investigated.

Conformal changes of proteins adsorbed on a micro-cantilever will give rise to a change in resonance frequency and stress of the micro-cantilever. Hereby, it is possible to study the conformal changes of proteins caused by external parameters such as pH-value, ion-concentration and temperature. For example the metalloprotein azurin adsorbed on gold is know to undergo conformational changes when subjected to different pH-values. How azurin binds to gold, and how the binding is changed when the pH-value is changed is not well understood, and the micro-cantilever-based measurements can give additional information on the binding properties. Many active enzyme functions also results in stress changes. Thereby enzyme activity levels in different environments can be investigated.

One of the major applications of the invention is the detection of multiple disease-associated genes. Single stranded DNA from the disease-associated genes is attached to micro-cantilevers by one of the coating technologies described above using conventional binding chemistry. Narrowly spaced micro-cantilevers placed in one channel can be coated with DNA sequences from different genes. A treated blood sample consisting of single stranded DNA is then flushed through the system. If one of the disease-associated genes is present in the sample it will bind specifically to the corresponding DNA string attached to the micro-cantilever. DNA strings, which have been non-specifically bounded can be detached by a heat treatment. The specific binding will result in a surface stress change as well as in a resonance change of the micro-cantilever. Hereby it is possible to perform a screening of several genes simultaneously. The method could also apply to DNA sequencing. The idea of screening for specific genes can be expanded to the detection of different antibodies. For this application closely spaced micro-cantilevers are coated with different antigens, using conventional binding chemistries. Antibodies bind specifically to antigens, whereby it is possible to screen for different antibodies in a blood sample.

Applying a conducting layer on the micro-cantilever and a reference electrode in the channel it is possible to perform electrodeposition and electrochemistry on layers on a micro-cantilever surface. For example in can be investigated how the stress in layers of mettaloproteins such as azurin and yeast cytochrom c respond to different potentials. Furthermore redox-processes might be monitored. Moreover, the adsorption and desorption of electrodepositable molecules can be investigated.

Furthermore, actuation of a compliant SU-8 based actuator structure can be realised by depositing on or encapsulating a thin gold film into the SU-8 based material. Using the fact that the gold and the SU-8 based material have different thermal expansion, the compliant SU-8 based actuator structure may be actuated due to the bimorph effect. For example, by integrating two gold films into the same compliant SU-8 based structure, such that the two gold films form a plate capacitor, both a sensor and an actuator based on the electrostatic (capacitive) principle can be obtained.

The compliant SU-8 based structure can also be bonded, glued or welled on pre-defined structures or substrates other than SU-8—for example, plastic, silicon, glass, or metals can be applied. Similarly, other realisations of sensors and actuators can involve the use of other polymers than SU-8 based polymers and other metals than gold.

Each of these embodiments and obvious variations thereof is contemplated as falling within the spirit and scope of the claimed invention, which is set forth in the following claims.

1. A flexible structure comprising integrated sensing means, said integrated sensing means being at least partly encapsulated in a flexible and electrically insulating body, said integrated sensing means further being adapted to sense deformations of the flexible structure.

2. A flexible structure according to claim 1, wherein the flexible and electrically insulating body is a polymer-based body.

3. A flexible structure according to claim 2, wherein the flexible polymer-based body is formed in a photosensitive polymer.

4. A flexible structure according to claim 3, wherein the photosensitive polymer is a SU-8 based polymer.

5. A flexible structure according to claim 4, wherein the SU-8 based polymer is an XP SU-8 polymer.

6. A flexible structure according to claim 3, wherein the photosensitive polymer is a polyimide polymer.

7. A flexible structure according to claim 3, wherein the photosensitive polymer is a BCB cyclotene polymer.

8. A flexible structure according to claims 2, wherein the flexible polymer-based body comprises by a first and a second polymer layer.

9. A flexible structure according to claim 8, wherein the integrated sensing means is at least partly embedded into the first and the second polymer layer.

10. A flexible structure according to claim 1, wherein the integrated sensing means comprises at least one resistor, the resistance of the at least one resistor being dependent on deformations of the flexible structure.

11. A flexible structure according to claim 10, wherein the at least one resistor is defined by a conducting layer.

12. A flexible structure according to claim 11, wherein the conducting layer is a metal layer.

13. A flexible structure according to claim 12, wherein the conducting layer is a gold layer.

14. A flexible structure according to claim 10, wherein the at least one resistor is defined by a semiconductor layer.

15. A flexible structure according to claim 14, wherein the semiconductor layer comprises silicon.

16. A chip comprising a flexible structure according to claim 1, the chip further comprising a substantially rigid portion comprising an integrated electrical conductor being at least partly encapsulated in an electrically insulating body, said integrated electrical conductor being connected to the integrated sensing means and being electrically accessible via a contact terminal on an exterior surface part of the substantially rigid portion.

17. A chip according to claim 16, wherein the substantially rigid portion comprises a first and a second polymer layer, and wherein the integrated electrical conductor is at least partly embedded into the first and the second polymer layer of the substantially rigid portion.

18. A chip according to claim 17, wherein the polymer layers of the substantially rigid portion are formed in photosensitive polymer layers.

19. A chip according to claim 17, wherein the integrated electrical conductor comprises a gold layer.

20. A chip according to claim 17, wherein the integrated electrical conductor comprises silicon.

21. A chip according to claim 17, further comprising at least three resistors, the at least three resistors forming part of the substantially rigid portion of the chip.

22. A chip according to claim 21, comprising three resistors.

23. A chip according to claim 22, wherein the three resistors are at least partly embedded into the first and the second polymer layer of the substantially rigid portion.

24. A chip comprising two flexible structures according to claim 10, the chip further comprising a substantially rigid portion comprising integrated electrical conductors each being at least partly encapsulated in an electrically insulating body, a number of said integrated electrical conductors being connected to the integrated sensing means and being electrically accessible via contact terminals on an exterior surface part of the substantially rigid portion.

25. A chip according to claim 24, further comprising two resistors, the two resistors forming part of the substantially rigid portion of the chip.

26. A chip according to claim 25, wherein the substantially rigid portion comprises a first and a second polymer layer, and wherein the integrated electrical conductors and the two resistors are at least partly embedded into the first and the second polymer layer of the substantially rigid portion of the chip.

27. A chip according to claim 25, wherein the four resistors are connected so as to form a Wheatstone Bridge.

28. A chip according to claim 16, further comprising a polymer-based substrate supporting the substantially rigid portion of the chip.

29. A chip according to claim 28, wherein the substrate is formed in a photosensitive polymer.

30. A chip according to claim 29, wherein the photosensitive polymer is a SU-8 based polymer.

31. A chip according to claim 30, wherein the SU-8 based polymer is a XP SU-8 polymer.

32. A chip according to claim 29, wherein the photosensitive polymer is a polyimide polymer.

33. A chip according to claim 29, wherein the photosensitive polymer is a BCB cyclotene polymer.

34. A chip according to claim 16, further comprising a silicon-based substrate supporting the substantially rigid portion of the chip.

35. A sensor for measuring the presence of a substance in a fluidic, said sensor comprising a chip according to claim 16.

36. An actuator comprising a flexible structure, said flexible structure comprising integrated actuator means being electrically accessible and being at least partly encapsulated in a flexible and electrically insulating body, said integrated actuator means being adapted to deform upon accessing the integrated actuator means electrically thereby inducing deformations of the flexible structure in accordance with deformations of the integrated actuator means.

37. An actuator according to claim 36, wherein the integrated actuator means comprises a metal layer, and wherein the flexible and electrically insulating body is a polymer-based body.

38. An actuator according to claim 37, wherein the polymer-based body is formed in a photosensitive polymer layer.

39. A chip according to claim 38, wherein the photosensitive polymer is a SU-8 based polymer.

40. A chip according to claim 39, wherein the SU-8 based polymer is a XP SU-8 polymer.

41. A chip according to claim 38, wherein the photosensitive polymer is a polyimide polymer.

42. A chip according to claim 38, wherein the photosensitive polymer is a BCB cyclotene polymer.

43. A chip comprising an actuator according to claim 36, further comprising a polymer-based substrate supporting a substantially rigid portion of the chip.

44. A chip according to claim 43, wherein the substrate is formed in a photosensitive polymer.

45. An actuator comprising an actuator according to claim 36, further comprising a silicon-based substrate supporting a substantially rigid portion of the chip.

46. A method of manufacturing a chip, the method comprising the steps of
providing a first electrically insulating layer,
patterning the first electrically insulating layer so as to form a first part of a flexible cantilever,
providing, onto a first area of the layer forming the first part of the flexible cantilever, a first conducting layer, and patterning the first conducting layer so as to form at least one conductor on the first area of the patterned first electrically insulating layer,
providing, onto a second and different area of the layer forming the first part of the flexible cantilever, a second conducting layer, and patterning the second conducting layer so as to form at least one resistor on the second area of the patterned first electrically insulating layer, and
providing, onto the first and second areas of the layer forming the first part of the flexible cantilever, a second electrically insulating layer so as to at least partly encapsulate the at least one conductor and the at least one resistor, and patterning the second electrically insulating layer so as to form a second part of a cantilever.

47. A method according to claim 46, wherein at least one conductor on the first area is connected to at least one resistor on the second area.

48. A method according to claim 46, wherein the electrically insulating layers are polymer layers.

49. A method according to claim 48, wherein the polymer layers are formed in photosensitive polymer layers.

50. A chip according to claim 49, wherein the photosensitive polymer is a SU-8 based polymer.

51. A chip according to claim 50, wherein the SU-8 based polymer is a XP SU-8 polymer.

52. A chip according to claim 49, wherein the photosensitive polymer is a polyimide polymer.

53. A chip according to claim 49, wherein the photosensitive polymer is a BCB cyclotene polymer.

54. A method according to claim 46, wherein the conducting layers are gold layers.

55. A method according to claim 46, further comprising the steps of providing a third layer onto the second electrically insulating layer, and patterning the third layer so as to form a substrate that only supports the first area of the second electrically insulating layer.

56. A method according to claim 55, wherein the third layer is formed in a photosensitive polymer layer.

57. A chip according to claim 56, wherein the photosensitive polymer is a SU-8 based polymer.

58. A chip according to claim 57, wherein the SU-8 based polymer is a XP SU-8 polymer.

59. A chip according to claim 56, wherein the photosensitive polymer is a polyimide polymer.

60. A chip according to claim 56, wherein the photosensitive polymer is a BCB cyclotene polymer.

61. A method according to claim 55, wherein the third layer is a silicon-based layer.

62. A method according to claim 55, further comprising the steps of
providing a sacrificial layer on a silicon wafer, upon which the first electrically insulating layer is provided, and
removing the silicon wafer after providing and patterning of the third layer.
